(19) United States
(12) Patent Application Publication
(10) Pub. No.: US 2013/0188355 A1
(43) Pub. Date: Jul. 25, 2013

(54) LAMP CHAIN, METHOD AND THE TOOLING FOR MAKING THE SAME

(71) Applicants: Huajian Fan, Shenzhen (CN); Yabin Luo, Shenzhen (CN); Canbang Yang, Shenzhen (CN); Zesheng Ye, Shenzhen (CN)

(72) Inventors: Huajian Fan, Shenzhen (CN); Yabin Luo, Shenzhen (CN); Canbang Yang, Shenzhen (CN); Zesheng Ye, Shenzhen (CN)

(73) Assignee: OSRAM GMBH, Muenchen (DE)

(21) Appl. No.: 13/822,325

(22) PCT Filed: Aug. 19, 2011
(86) PCT No.: PCT/EP2011/064314

§ 371 Date: Apr. 15, 2013

(30) Foreign Application Priority Data
Sep. 13, 2010 (CN) 201010290156.X

(51) Int. Cl. F21S 4/00

(52) U.S. Cl. CPC F21S 4/008
USPC 362/240; 264/261; 425/110

(57) ABSTRACT

A method for making a lamp chain may include: a) providing a tooling provided with a cavity therein, wherein multiple lens-like holes spaced apart from each other at a predetermined distance are formed in the bottom of the cavity; b) placing a circuit board mounted with multiple illuminants in the cavity and keeping the circuit board away from the bottom of the cavity at a predetermined distance; wherein the multiple lens-like holes correspond to the positions of the multiple illuminants at the circuit board; c) injecting glue into the cavity until the glue fully fills the cavity; and d) solidifying the glue.

### TECHNICAL FIELD

The present invention relates to a lamp chain and a method and a tooling for making the lamp chain.

### BACKGROUND ART

A lamp chain is widely used in advertising boards, lighting indication boards, and etc. The lamp chain is usually used in an outdoor environment, and thus its properties such as waterproof and anti-dust should be ensured. In the prior art, the following methods are usually used to make the lamp chain. One method is to first provide a U shaped bottom board into which a circuit is placed mounted with multiple illuminants, and then to coat a transparent sealing material above the same, and to package the circuit board. Another method is to first provide a tubular housing with an end-side opening, to place a circuit board mounted with multiple illuminants into the tubular transparent housing, then to fill into the housing a filing material from the end-side opening and to package the circuit board. A third method is to provide a tooling with a cavity, to place the circuit board into the tooling, to inject a filling material into the cavity, and then to take away the tooling after the filling material has been solidified. The lamp chains obtained from the above three methods do not provide any other optical designs except the illuminants (usually LED), and thus adjustment of light distribution is limited. In addition, the overall lamp chains do not have any design relating to mechanical structures for mounting the lamp chain.

### SUMMARY OF THE INVENTION

The present invention aims to provide a novel method for making a lamp chain. The lamp chain realizes at low cost and high efficiency optical properties of a lamp, especially adjustment of light distribution. A further object of the present invention is to form the lamp chain mounting portions for mounting the lamp chain at low cost and high efficiency.

The first object of the present invention is realized via the following process: a method for making a lamp chain, comprising the following steps: providing a tooling provided with a cavity therein, wherein multiple lens-like holes spaced apart from each other at a predetermined distance are formed in the bottom of the cavity; placing a circuit board mounted with multiple illuminants in the cavity and keeping the circuit board away from the bottom of the cavity at a predetermined distance; wherein the multiple lens-like holes correspond to of the multiple illuminants in terms of position at the circuit board; injecting glue into the cavity until the glue fully fills the cavity; and solidifying the glue to obtain the lamp chain. In the present invention, via directly forming in the bottom of the cavity of the tooling multiple lens-like holes spaced apart from each other at a predetermined distance, when the glue is filled, the glue will fully fill the lens-like holes. After the glue has been solidified and the tooling has been removed, multiple lenses will be generated at the housing made from glue, and as the position of multiple lens-like holes correspond to the positions of the multiple illuminants at the circuit board, each lens provides light distribution of the each illuminants it corresponds to, thereby realizing at low cost and high efficiency optical properties of a lamp, especially adjustment of light distribution.

Preferably, in step a), multiple protrusions which are provided at the bottom of the cavity of the tooling and are spaced apart from each other are used to form a plurality of mounting portions of the lamp chain. After the glue has been solidified and the tooling has been removed, grooves will be formed on the same surface with the lenses. Thus the lamp chain can be conveniently mounted to a mounting position during mounting.

Preferably, in step b), a support portion which is formed at the inner side wall of the tooling are used to ensure that the circuit board is kept away from the bottom of the cavity at the predetermined distance. Thus, during filling the glue, the influence of the circuit board on the formation of the lenses will be minimized. Also, this should be appropriate distance for the lamp and the lens.

Preferably, in step d), the glue is solidified by baking. Thus, the speed of solidifying the glue can be expedited via baking. This can greatly reduce the time of solidifying the glue and improves the production efficiency.

Correspondingly the present invention provides a tooling used for enclosing a circuit board mounted with multiple illuminants to form a lamp chain, characterized in that, the tooling have a cavity to accommodate the circuit board, wherein multiple lens-like holes spaced apart from each other at a predetermined distance are formed in the bottom of the cavity, each lens-like hole correspond to respective illuminant in terms of position. Preferably, multiple protrusions for forming a plurality of mounting portions of the lamp chain are provided at the bottom of the cavity and are spaced apart from each other. Preferably, a support portion for keeping the circuit board from the bottom of the cavity at the predetermined distance are formed at the inner side wall of the tooling.

Correspondingly the present invention provides a lamp chain. The lamp chain according to the present invention comprises: a housing, a circuit board provided within the housing, and multiple illuminants provided at the circuit board, wherein the housing is provided at its outer surface with multiple lenses corresponding to the illuminants in terms of positions, and the lenses are formed in one piece with the housing. Thus, a lamp chain with an improved light distribution property is obtained at low cost.

Preferably, the housing is formed integrally at its outer surface with mounting portions for hanging the lamp chain. More preferably, the mounting portions are multiple grooves distributed with an distance therebetween. Thus, the mounting portions of the lamp chain are realized at low cost.

Preferably, the housing is made from one material selected from a PU glue and a silicon gel. Thus, light transmittance is achieved while cost is lowered. Preferably, the circuit board is a flexible circuit board and thus a flexible lamp chain is formed.

The method for making a lamp chain and a corresponding lamp chain according to the present invention can realize at low cost and high efficiency optical properties of a lamp, especially adjustment of light distribution, and the present invention realizes at low cost and high efficiency forming at the lamp chain mounting portions for mounting the lamp chain.

### BRIEF DESCRIPTION OF THE DRAWINGS

The preferable embodiments according to the present invention will be illustratively described hereinafter with reference to the figures. As shown in the drawings:

FIG. 1 illustrates the lamp chain according to the present invention observed at the lenses side;

FIG. 2 is an enlarged view of the lenses and the mounting portions according to the present invention;

FIG. 3 illustrates a perspective view of the present invention, wherein the circuit board in the housing and multiple LED lamps provided at the circuit board are shown;

FIG. 4 is a schematic view of the tooling for making the lamp chain; and

FIG. 5 is a flow chart of the making method according to the present invention.

### DETAILED DESCRIPTION OF THE EMBODIMENTS

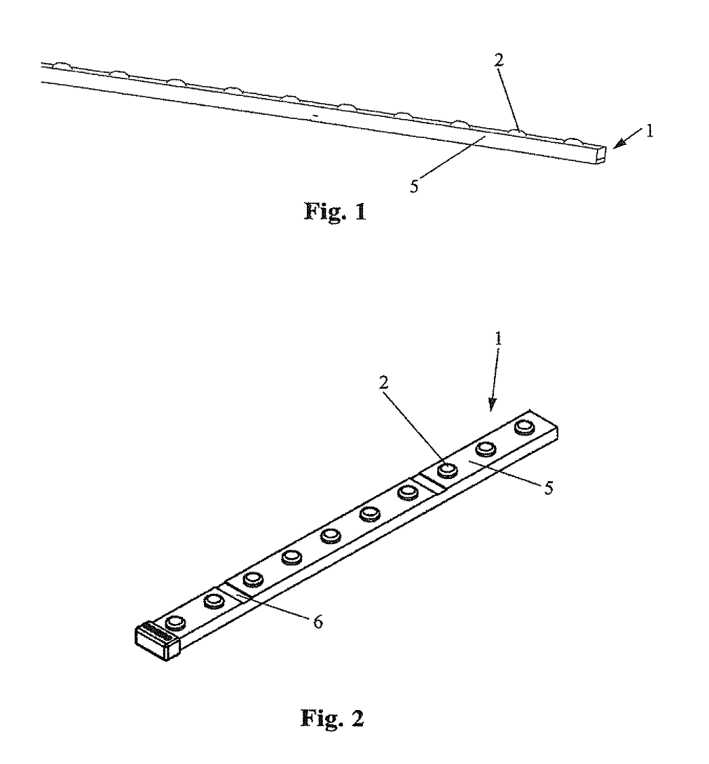

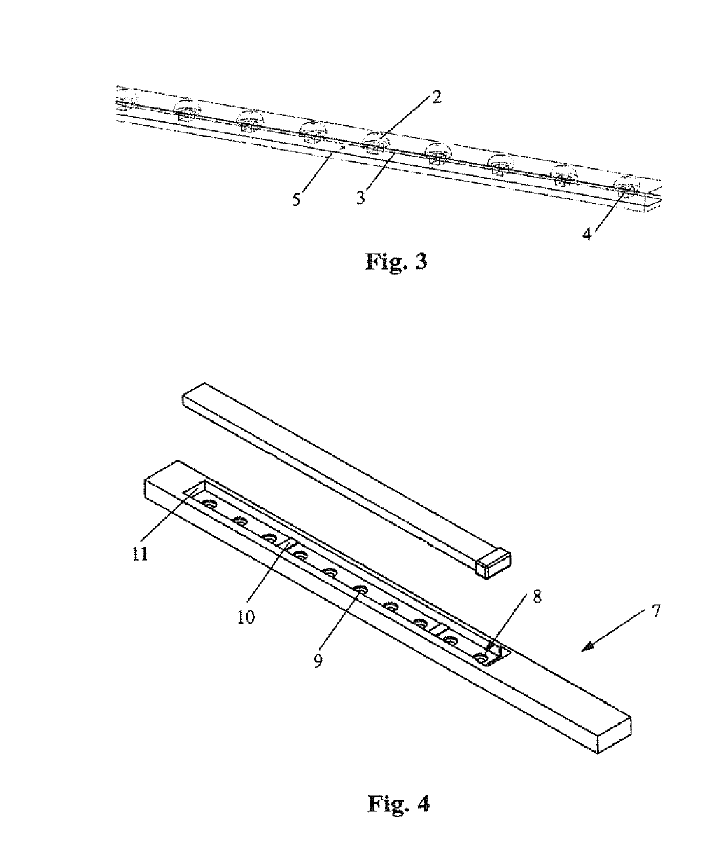

FIG. 1 illustrates the lamp chain 1 according to the present invention observed at the lenses 2 side. The lamp chain 1 includes lenses distributed with an distance therebetween protruding from the housing 5. The lenses 2 are formed in one piece with the housing 5. The two can be made from one material of a PU glue and a silicon gel. The positions of the lenses 2 at an outer surface correspond one by one to the positions of the LED lamps 4 (shown in FIG. 3) at the circuit board 3 provided in the housing 5. Thus, it is ensured that the light of the LED lamps 4 can be emitted from the lenses 2 and can be subjected to optical adjustment, especially light distribution adjustment.

FIG. 2 is an enlarged view of the lenses and the mounting portions according to the present invention. Seen from FIG. 2 clearly, multiple lenses 2 distributed with an distance therebetween and multiple mounting portions 6 are arranged on housing 5, and the multiple lenses 2 and the multiple mounting portions 6 are all formed in one piece with the housing 5. The simplest form of the mounting portions 6 is groove.

FIG. 3 illustrates a perspective view of the present invention, wherein the circuit board 3 in the housing 5 and multiple LED lamps 4 provided at the circuit board are shown. The circuit board 3 can be flexible. Especially, the positions of the LED lamps 4 correspond one by one to the positions of the lenses 2, and they keep a certain distance therebetween.

FIG. 4 is a schematic view of the tooling 7 for making the lamp chain 1. Seen from FIG. 4, the tooling 7 is provided with a cavity 8 therein, and the cavity 8 is provided at its bottom with multiple lens-like holes 9 and protrusions 10 for forming the lenses 2 and the mounting portions 6, respectively. A support portion 11 is formed at the inner side wall of the tooling 7 to support the circuit board 3 during filling, so that the circuit board keeps a predetermined distance with respect to the bottom of the cavity 8. The predetermined distance should not affect that the light of the LED lamps 4 is emitted from the lenses 2 and should not affect the formation of the lenses 2. The positions of the multiple lens-like holes 9 are determined according to the mounting positions of the LED lamps 4 at the circuit board 3.

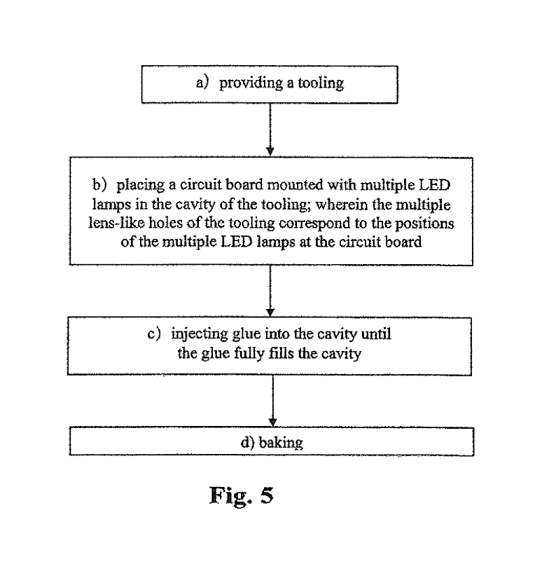

FIG. 5 is a flow chart of the making method according to the present invention, comprising steps: a) providing a tooling 7, preferably an AL-made tooling; b) placing a circuit board 3 mounted with multiple LED lamps 4 in the cavity 8 of the tooling 7 and keeping the circuit board 3 away from the bottom of the cavity 8 at a predetermined distance; wherein the multiple lens-like holes 9 of the tooling 7 correspond to the positions of the multiple LED lamps at the circuit board 3; c) injecting glue into the cavity 8 until the glue fully fills the cavity, and covers the circuit board, the protrusions 10 of the cavity 8 and the holes 9; and d) to expedite solidifying the glue, baking can be performed to reduce the time of the method. Finally, the glue forms the housing, lenses 2 formed in one piece with the housing, and mounting portions 6 in the form of grooves for the lamp chain.

### List of Reference Signs

1 lamp chain

2 lens

3 circuit board

4 LED lamp

5 housing

6 mounting portion

7 tooling

8 cavity

9 lens-like hole

10 protrusion

11 support portion

1. A method for making a lamp chain, the method comprising:
a) providing a tooling provided with a cavity therein, wherein multiple lens-like holes spaced apart from each other at a predetermined distance are formed in the bottom of the cavity;
b) placing a circuit board mounted with multiple illuminants in the cavity and keeping the circuit board away from the bottom of the cavity at a predetermined distance; wherein the multiple lens-like holes correspond to the positions of the multiple illuminants at the circuit board;
c) injecting glue into the cavity until the glue fully fills the cavity; and
d) solidifying the glue.

2. The method according to claim 1, wherein in a), multiple protrusions which are provided at the bottom of the cavity of the tooling and are spaced apart from each other are used to form a plurality of mounting portions of the lamp chain.

3. The method according to claim 1, wherein in b), a support portion which is formed at the inner side wall of the tooling are used to ensure that the circuit board is kept away from the bottom of the cavity at the predetermined distance.

4. The method according to claim 1, wherein in d), the glue is solidified by baking.

5. A lamp chain manufactured by a method, the method comprising:
a) providing a tooling provided with a cavity therein, wherein multiple lens-like holes spaced apart from each other at a predetermined distance are formed in the bottom of the cavity;
b) placing a circuit board mounted with multiple illuminants in the cavity and keeping the circuit board away from the bottom of the cavity at a predetermined distance; wherein the multiple lens-like holes correspond to the positions of the multiple illuminants at the circuit board;
c) injecting glue into the cavity until the glue fully fills the cavity; and
d) solidifying the glue.

6. A tooling used for enclosing a circuit board mounted with multiple illuminants to form a lamp chain, the tooling comprising:
a cavity to accommodate the circuit board,
wherein multiple lens-like holes spaced apart from each other at a predetermined distance are formed in the bottom of the cavity,
wherein each lens-like hole corresponds to respective illuminant in terms of position.

7. A tooling according to claim 6,
wherein multiple protrusions for forming a plurality of mounting portions of the lamp chain are provided at the bottom of the cavity and are spaced apart from each other.

8. A tooling according to claim 6, wherein a support portion for keeping the circuit board from the bottom of the cavity at the predetermined distance are formed at the inner side wall of the tooling.

9. A lamp chain, comprising:
a housing,
a circuit board arranged in the housing, and
multiple illuminants provided at the circuit board,
wherein the housing is provided at its outer surface with multiple lenses corresponding to the illuminants in terms of position, and the lenses are formed in one piece with the housing.

10. The lamp chain according to claim 9, wherein the housing is formed integrally at its outer surface with mounting portions for hanging the lamp chain.

11. The lamp chain according to claim 10, wherein the mounting portions are multiple grooves distributed with an distance therebetween.

12. The lamp chain according to claim 9,
wherein the housing is made from one material selected from a PU glue and a silicon gel.

13. The lamp chain according to claim 9,
wherein the circuit board is a flexible circuit board.
